(19) United States
(12) Patent Application Publication
(10) Pub. No.: US 2006/0017033 A1
(43) Pub. Date: Jan. 26, 2006

(54) Electromagnetic valve

(76) Inventor: Christoph Voss, SchafflestraBe (DE)

Correspondence Address: RATNERPRESTIA, P O BOX 980, VALLEY FORGE, PA, 19482-0980, US

(21) Appl. No.: 10/536,522

(22) PCT Filed: Dec. 9, 2003
(86) PCT No.: PCT/EP03/13935

§ 371 Date: May 25, 2005

(30) Foreign Application Priority Data
Dec. 13, 2002 (DE) 102 58 268.8
May 26, 2003 (DE) 103 23 656.2
Sep. 23, 2003 (DE) 103 43 841.6

(51) Int. Cl. F16K 31/02

(52) U.S. Cl. 251/129.19

(57) ABSTRACT

The invention relates to an electromagnetic valve with a valve-accommodating member into which a section of a first tubular body remote from a second tubular body is inserted in a pressure-fluid tight manner, with the section of the second tubular body facing the first tubular body being secured to the valve-accommodating member and the section of the first tubular body facing the second tubular body being inserted into the second tubular body and the first tubular body being supported on a stop surface of the second tubular body whereby a simple and tight tubular connection is provided.

### TECHNICAL FIELD

The present invention relates to an electromagnetic valve.

DE 199 28 750 A1 discloses an electromagnetic valve of the type of construction that is closed in the basic position, and the two tubular bodies thereof are welded or joined by folding to form the valve housing. The manufacturing effort needed for this operation is relatively high.

An object of the invention is to manufacture an electromagnetic valve of the type indicated hereinabove with least possible effort and structure so that there is no need for a welding or folding joint between the two tubular bodies.

### BRIEF DESCRIPTION OF THE EMBODIMENTS

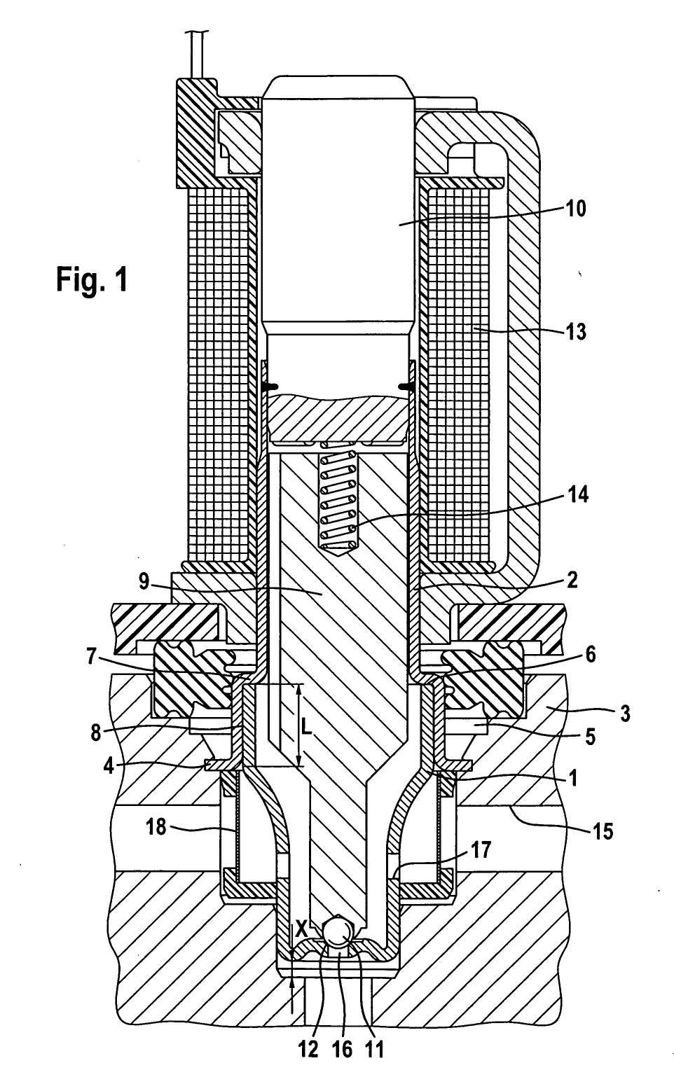

FIG. 1 is a longitudinal cross-section taken through an electromagnetic valve that is calked in a stepped bore of a valve-accommodating member.

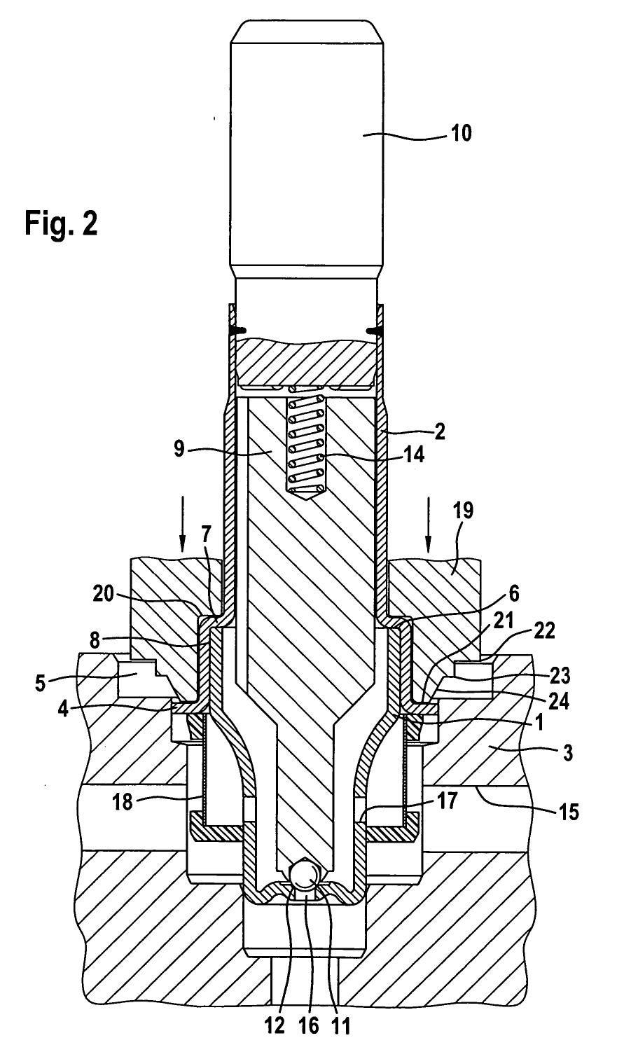

FIG. 2 is a view of the electromagnetic valve of FIG. 1 prior to the calking operation by means of a calking tool in the valve-accommodating member.

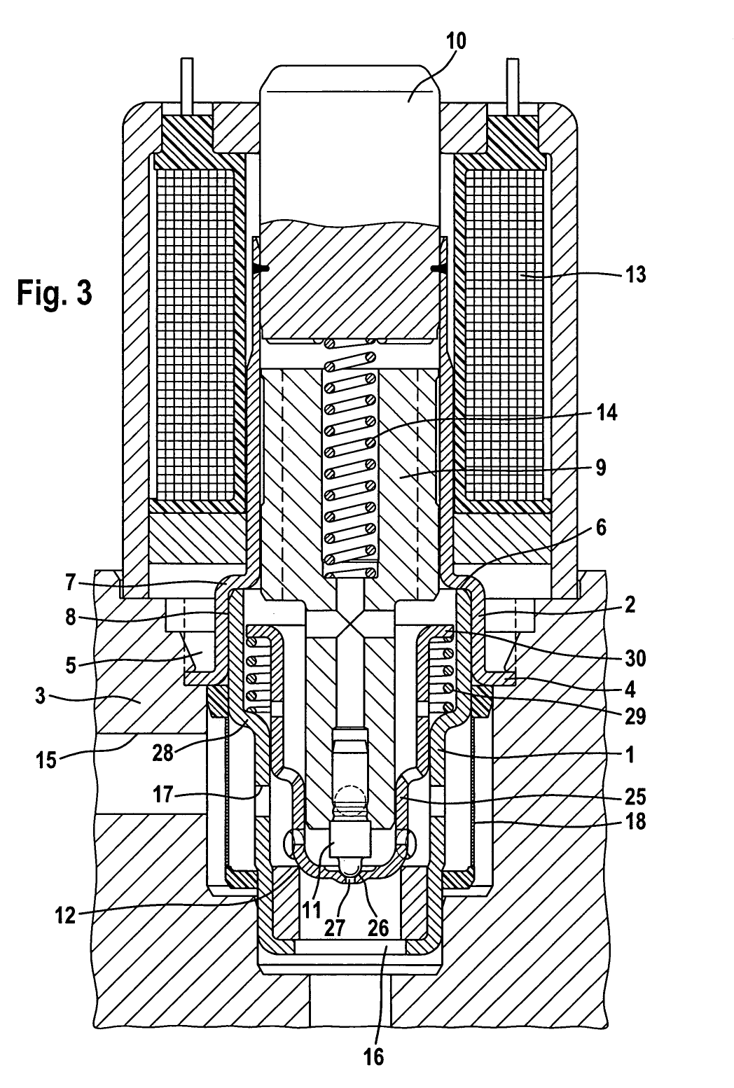

FIG. 3 is a longitudinal cross-section taken through an electromagnetic valve configured as a two-stage valve, having its further valve closure member guided directly in the first tubular body.

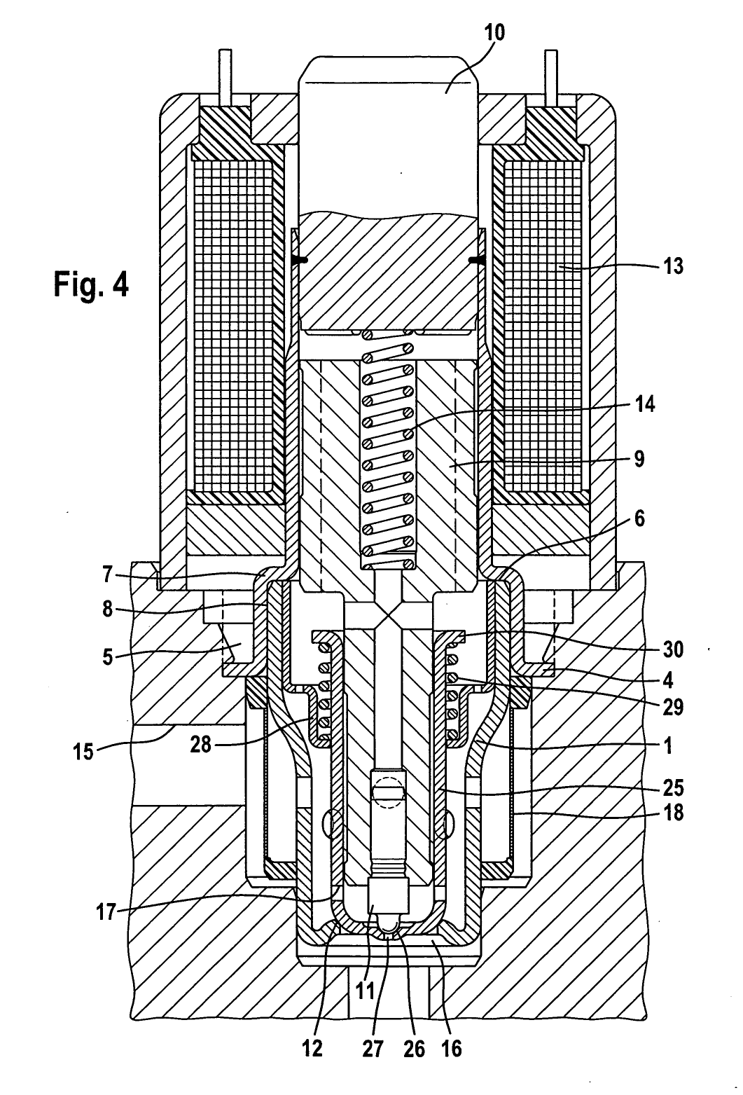

FIG. 4 is a longitudinal cross-section taken through an electromagnetic valve configured as a two-stage valve, having its further valve closure member guided in a spring stop separately inserted into the tubular body.

### DETAILED DESCRIPTION OF THE PREFERRED EMBODIMENTS

FIG. 1 shows in a considerably enlarged view a longitudinal cross-section taken through an electromagnetic valve closed in its basic position, with a valve housing accommodating an armature 9, a magnet core part 10, a valve closure member 11 and a valve seat 12, said housing being formed of a first and a second tubular body 1, 2, with said two tubular bodies 1, 2 being joined in sections coaxially in each other with their facing open ends. The electromagnetic valve is secured in a block-shaped valve-accommodating member 3 into which the tubular section of the first tubular body 1 remote from the second tubular body 2 is inserted in a pressure-fluid tight manner. The tubular section of the second tubular body 2 remote from the first tubular body 1 carries a magnet coil 13 outside the valve-accommodating member 3. Magnet coil 13 extends along the plug-shaped magnet core part 10, which closes the end of the second tubular body 2 projecting from the valve-accommodating member 3. Interposed between the magnet core part 10 and the valve seat 12 designed on the bottom of the first bowl-shaped tubular body 1 is the armature 9 carrying the valve closure member 11 and extending along the inside wall of the second tubular body 2. Due to the effect of a compression spring 14 compressed between the magnet core part 10 and the armature 9, the valve closure member 11 that is press-fitted as a ball into the end of the armature 9 closes the pressure fluid opening in the valve seat 12 in the initial position according to the drawing. The valve seat 12 is preferably formed in a stamping operation into the bowl bottom of the deepdrawn second tubular body 2 in a precise and nevertheless low-cost manner. The peripheral surface of the second tubular body 2 includes another opening 17 at the level of a transverse channel 15 penetrating the valve-accommodating member 3, said opening 17 being made in a stamping operation exactly as opening 16 in the valve seat 12. A ring filter 18 being supported in the stepped bore 5 on a bead 4 of the second tubular body 2 and below the opening 17 at the first tubular body 1 prevents the ingress of dirt into the armature chamber from the direction of the transverse channel 15. A channel opening below the valve seat 12 into the stepped bore 5 is also equipped with a filter, if so desired or required.

The invention arranges that the section of the second tubular body 2 facing the first tubular body 1 is secured directly at the valve accommodating member 3 and that the section of the first tubular body 1 facing the second tubular body 2 is inserted into the second tubular body 2 and supported on an stop surface 6 of the second tubular body 2. This renders possible a particularly simple, tight and safe connection of the first tubular body 1 and the second tubular body 2 within the valve-accommodating member 3 because the two tubular bodies 1, 2 with the single valve parts, which are pre-assembled therein so as to be operable, are simply press-fitted into the stepped bore 5 by means of a calking tool 19, without the need for a welding or folding connection.

A surprisingly simple fixation of the tubular body 2 is achieved when the end of the second tubular body 2 facing the valve-accommodating member 3 includes a bead 4, e.g. in the shape of a flange, that is directed radially outwards and fastened in a stepped bore 5 of the valve-accommodating member. An absolutely tight, undetachable attachment of the bead 4 in the stepped bore 5 is provided by the plastic deformation of material of the valve-accommodating member 3 by means of the calking tool 19 embracing the bead 4 at least along its edge.

To manufacture the stop surface 6, the second tubular body 2 is provided with a housing step 7 having an inside diameter at the end of the joining portion 8 of both tubular bodies 1, 2 that is selected to be smaller than the outside diameter of the first tubular body 1 in the area of the joining portion 8. Likewise the housing step 7 is manufactured at low costs by a plastic deformation of the second tubular body 2 in the end area of the joining portion 8 and preferably designed as an S-shaped double crank.

The first and second tubular bodies 1, 2 are comprised of thin-walled deepdrawn sleeves being interconnected by a press fit in the joining portion 8.

The first, bowl-shaped tubular body 1 is supported with its end remote from the joining portion 8 in the second tubular body 2 in the stepped bore 5 of the valve-accommodating member 3 in a pressure-fluid tight manner, with the axial distance X between the bowl bottom of the first tubular body 1 and the bottom of the stepped bore 5 being smaller than the length L of the overlapping of both tubular bodies 1, 2 in the area of the joining portion 8 so that a sufficient overlapping of the two tubular bodies 1, 2 in the joining portion 8 is maintained in order to safeguard operability even if the press fit connection between the first and second tubular bodies 1, 2 loosens.

Different from the illustration in FIG. 1, FIG. 2 shows the electromagnetic valve during the assembly in the valve-accommodating member 3, to what end the hollow-cylindrical calking tool 19 is slipped over the second tubular body 2 and, at the inside periphery, is supported with an inside shoulder 20 on the housing step 7 and with its outside shoulder 21 on bead 4. The outside periphery of the calking tool 19 is provided with two housing steps 22, 23 adjacent to which is a conical portion 24 in the direction of the plane outside shoulder 21. The result is a calking tool 19 decreasing in its outside diameter in the direction of the stepped bore 5 and displacing the material of the bore step of the valve-accommodating member 3 in the direction of the conical portion 24 by means of the second housing step 23 until finally likewise the first housing step 22 abuts on the non-deformed housing portion of the stepped bore 5. At the moment when the first housing step 22 abuts on the non-deformable housing portion of the stepped bore 5, the conical calked point at bead 4 is achieved, as illustrated in FIG. 1, which ensures a tight and rigid connection of the electromagnetic valve with the valve-accommodating member 3.

FIGS. 3 and 4 show in each case a considerably enlarged view of a longitudinal cross-section taken through an electromagnetic valve that is closed in its basic position. The housing of said valve including an armature 9, a magnet core part 10, two valve closure members 11, 25 and two valve seats 12, 26 is formed of a first and a second tubular body 1, 2, with the two tubular bodies 1, 2 being press-fitted in sections coaxially into each other with their open ends facing each other. It must be noted in addition that all other cited single parts are also arranged coaxially in a defined order within the valve housing.

The electromagnetic valve illustrated in FIGS. 3, 4 is secured in a block-shaped valve-accommodating member 3 in which the tubular section of the first tubular body 1 that is remote from the first tubular body 1 is inserted so as to be pressure-fluid tight. The tubular section of the second tubular body 2 remote from the first tubular body 1 carries a magnet coil 13 outside the valve-accommodating member 3. Said magnet coil 13 extends along the plug-shaped magnet core part 10 which closes the end of the second tubular body 2 projecting from the valve-accommodating member 3. Interposed between the magnet core part 10 and the first bowl-shaped tubular body 1 is the armature 9 that carries the valve closure member 11 and is guided along the inside wall of the second tubular body 2. Due to the effect of a compression spring 14 compressed between the magnet core part 10 and the armature 9, the spherical valve closure member 11 provided with a tappet and press-fitted into the open end of the armature 9 will close the orifice-type opening 27 of the other valve closure member 25 in the basic position shown in the drawing, in whose bowl bottom the so-called further valve seat 26 is arranged that delimits the opening 27. Valve seat 26 is shaped in the bowl bottom of the valve closure member 25, preferably in a stamping operation in a low-cost and precise fashion.

The so-called further valve closure member 25 is composed of a sleeve bowl that is axially movable in the first tubular body 1, deepdrawn from thin sheets and also thermally treated, if required. The sleeve's bowl bottom assumes the proper function of the valve closure member 25 (quasi in the function of a valve piston), which is pressed against the valve seat 12 fixed in the first tubular body 1 in a sealing fashion, what is done by the action of force of compression spring 14 in the basic position.

It can be taken from the embodiments of FIGS. 3 and 4 that the inside diameter of the first tubular body 1 is adapted at least in sections to the outside diameter of the further valve closure member 25 for the purpose of a precise accommodation and guiding of the further valve accommodating member 25 corresponding with the valve closure member 11. In this arrangement, it is required to provide a sufficiently sized clearance fit between the first tubular body 1 and the outside wall of the bowl-shaped valve closure member 25 to enable the further valve closure member 25 to move in a clamping-free manner and center itself at the valve seat 12.

In FIG. 3, the valve seat 12 is designed as a massive valve plate, which is adapted to be separately handled and is shaped in a stamping operation directly in the bottom of the deepdrawn first tubular body 1 in a low-cost and precise fashion alternatively in FIG. 2.

In FIGS. 3 and 4 the peripheral surface of the first tubular body 1 includes several openings 17 at the level of a transverse channel 15 that opens laterally into the valve-accommodating member 3. Openings 17 are manufactured in a stamping operation exactly as the orifice-type opening 27 arranged in the bowl bottom of the valve closure member 25. A ring filter 18 supported in the stepped bore 5 on a bead 4 of the second tubular body 2 and beneath the opening 18 at the first tubular body 1 prevents dirt from entering the valve housing from the direction of the transverse channel 15. Of course, a channel opening into the stepped bore 5 below the valve seat 12 can also be provided with a filter, if desired or required.

In FIGS. 3 and 4 the section of the second tubular body 2 facing the first tubular body 1 is fastened directly at the valve-accommodating member 3, and the section of the first tubular body 1 facing the second tubular body 2 is inserted in a press fit into the second tubular body 2 and supported on a stop surface 6 of the second tubular body 2. This renders possible a particularly simple, tight and safe connection between the first tubular body 1 and the second tubular body 2 within the valve-accommodating member 3 because the two tubular bodies 1, 2 along with the single valve parts, which are pre-assembled therein so as to be operable, are straightforwardly press-fitted into the stepped bore 5 by means of a calking tool, without requiring a welded or folded connection.

Further, a spring stop 28 is provided at the first tubular body 1 in both illustrations for supporting another compression spring 29. According to the drawings, the further compression spring 29 is compressed between the spring stop 28 and the further valve closure member 25 so that the further compression spring 29 counteracts the compression spring 14 in a simple fashion, which latter is interposed between the armature 9 and the magnet core part 10.

To be able to support the one end of the further compression spring 29 on the valve closure member 25 in a simple manner, the sleeve end of the valve closure member 25 remote from the bowl bottom is bent at angles in a radially outward direction towards the first tubular body 1 to form a collar 30.

In the embodiment of FIG. 3 the spring stop 28 is manufactured in a particularly inexpensive way directly by way of a shoulder of the first tubular body 1 constricted like a step in the deepdrawing process.

On the other hand, the spring stop 28 in the embodiment of FIG. 4 is preferably designed as a thin-walled deepdrawn guiding sleeve that is inserted separately into the first tubular body 1. At its bottom sleeve end, through which the further valve closure member 25 extends in the direction of the valve seat 12, the guiding sleeve includes an edge cranked in the direction of the sleeve's longitudinal axis, on which edge the one end of the compression spring 29 abuts. In the area of overlapping of both tubular bodies 1, 2, the sleeve-shaped spring stop has a guiding portion that abuts on the inside wall of the first tubular body 1 in a clearance-free manner in order to properly center the spring stop 28 in the valve housing.

Instead of the guiding sleeve, it would alternatively be feasible to design the spring stop 28 as an insert member in the shape of a flat disc.

To sum up, it can now be stated that the adept dimensioning of the electromagnetic valve in the area of the first tubular body 1 achieves optimal structural conditions in order to configure the electromagnetic valve in a particularly space-saving manner as a two-stage valve by using a smallest possible number of easy-to-make components.

This is because the electromagnetic valve includes a supply restriction stage formed of the valve closure member 11 and the further valve seat 26 as well as a main stage. Upon electromagnetic energization of the armature 9, the supply restriction stage is effective due to the valve closure member 11 lifting from the (further) valve seat 26, with the result that the orifice-type opening 27 is released by means of the valve closure member 11. The unrestricted main stage is only effective when the supply restriction stage is opened and, in the balance of forces, the valve opening force exerted by the compression spring 29 exceeds the hydraulic forces that act on the valve closure member 25 so that the valve closure member 25 mainly formed by the bowl bottom lifts from the valve seat 11 by the action of the compression spring 29, whereby the large flow cross-section of opening 16 is opened.

1-17. (canceled)

18. An electromagnetic valve comprising:
a valve housing accommodating an armature, a magnet core part, a valve closure member and a valve seat, said housing being formed of a first and a second tubular body, said two tubular bodies with their ends being joined in sections in each other and including a joining portion, a valve-accommodating member into which the section of the first tubular body remote from the second tubular body is inserted in a pressure-fluid tight manner, the section of the second tubular body remote from the first tubular body carrying a magnet coil outside the valve-accommodating member, wherein the section of the second tubular body facing the first tubular body is secured to the valve-accommodating member, and in that the section of the first tubular body facing the second tubular body is inserted into the second tubular body and directed to a stop surface of the second tubular body.

19. The electromagnetic valve as claimed in claim 18,
wherein the end of the second tubular body facing the valve-accommodating member includes a bead that is directed radially outwards and fastened in a stepped bore of the valve-accommodating member.

20. The electromagnetic valve as claimed in claim 19,
wherein the bead is attached in the stepped bore by way of the plastic deformation of material of the valve-accommodating member that embraces the bead.

21. The electromagnetic valve as claimed in claim 18,
wherein for manufacturing the stop surface, the second tubular body is provided with a housing step having an inside diameter at the end of the joining portion of both tubular bodies that is selected to be smaller than the outside diameter of the first tubular body in the area of the joining portion.

22. The electromagnetic valve as claimed in claim 21,
wherein the housing step is manufactured by means of a plastic deformation of the second tubular body in an end area of the joining portion being disposed remote from the open end of the second tubular body.

23. The electromagnetic valve as claimed in claim 22,
wherein the housing step is manufactured by a double crank in the end area of the joining portion.

24. The electromagnetic valve as claimed in claim 21,
wherein the first and second tubular bodies are comprised of thin-walled deepdrawn sleeves being interconnected by a press fit in the joining portion.

25. The electromagnetic valve as claimed in claim 21,
wherein the first tubular body is supported with its end remote from the joining portion in a stepped bore of the valve-accommodating member in a pressure-fluid tight manner, with the axial distance between the first tubular body and a bottom of the stepped bore being smaller than the length of the overlapping of both tubular bodies in the area of the joining portion.

26. The electromagnetic valve as claimed in claim 22,
wherein the housing step and/or the bead, for the assembly and calking of the second tubular body in the valve-accommodating member, receive a hollow-cylindrical calking tool that is supported with its inside shoulder on the housing step and/or with its outside shoulder on the bead.

27. The electromagnetic valve as claimed in claim 26,
wherein the outside periphery of the calking tool is provided with two housing steps adjacent to which is a conical portion in the direction of the plane outside shoulder, and in that the second housing step is used to displace the material of the bore step of the valve-accommodating member in the direction of the conical portion.

28. The electromagnetic valve as claimed in claim 18,
wherein the inside diameter of the first tubular body is adapted at least in sections to the outside diameter of the further valve closure member for the purpose of accommodating a further valve accommodating member corresponding with the valve closure member.

29. The electromagnetic valve as claimed in claim 28,
wherein the further valve closure member is formed of a sleeve bowl guided in the first tubular body having its bowl bottom pressed against the valve seat in a sealing manner by the action of a compression spring in the basic position.

30. The electromagnetic valve as claimed in claim 29,
wherein the bowl bottom contains an opening which is delimited by a further valve seat and closed by the valve closure member in the valve's basic position.

31. The electromagnetic valve as claimed in claim 28,
wherein the first tubular body includes a spring stop for supporting a further compression spring that is compressed between the spring stop and the further valve closure member, and in that the further compression spring counteracts the compression spring that is interposed between the armature and the magnet core part.

32. The electromagnetic valve as claimed in claim 31,
wherein the further valve closure member at its sleeve end remote from the bowl bottom is bent at angles in a radially outward direction to form a collar on which the one end of the further compression spring is supported.

33. The electromagnetic valve as claimed in claim 31,
wherein the spring stop is formed directly by way of a shoulder of the first tubular body constricted like a step.

34. The electromagnetic valve as claimed in claim 31,
wherein the spring stop is either designed as a guiding sleeve that is inserted separately into the first tubular body, or as a flat disc through which the further valve closure member extends in the direction of the valve seat.
